(19) United States
(12) Patent Application Publication
(10) Pub. No.: US 2025/0012636 A1
(43) Pub. Date: Jan. 9, 2025

(54) ASCERTAINMENT OF A WAVEFRONT GRADIENT OF A LIGHT ON THE BASIS OF ANGLE-DEPENDENT TRANSMISSION

(71) Applicant: FRAUNHOFER-GESELLSCHAFT ZUR FÖRDERUNG DER ANGEWANDTEN FORSCHUNG E.V., München (DE)

(72) Inventors: Andreas ZEPP, Ettlingen (DE); Szymon GLADYSZ, Ettlingen (DE)

(73) Assignee: FRAUNHOFER-GESELLSCHAFT ZUR FÖRDERUNG DER ANGEWANDTEN FORSCHUNG E.V., München (DE)

(21) Appl. No.: 18/710,022

(22) PCT Filed: Nov. 15, 2022
(86) PCT No.: PCT/EP2022/081877

§ 371 Date: May 14, 2024

(30) Foreign Application Priority Data
Nov. 16, 2021 (DE) 10 2021 129 821.0

(51) Int. Cl. G01J 9/02; G01J 9/00

(52) U.S. Cl. CPC G01J 9/02; G01J 2009/002; G01J 2009/0257

(57) ABSTRACT

Disclosed is a method for determining a wavefront gradient, the method involving irradiating a transmission filter unit with a light and measuring the intensity of light transmitted, followed by another irradiating and measuring of the light transmitted, and calculating a spatial contrast K from a difference of the first intensity and the second intensity and also calculating a local wavefront gradient from the K value and a calibration factor c.

The present disclosure relates to the determination of a wavefront slope of a light, in particular a laser light, comprising an irradiation of a transmission filter unit with a light with different angles between the light and a main transmission direction of the transmission filter unit for the light, and also a measurement of an intensity of the light transmitted through the transmission filter unit for the different angles.

Wavefront sensors are used to measure wavefronts of light and in particular to determine the deviation of real wavefronts from ideal, perfect wavefronts. The measured deviations from the ideal wavefront are caused by optical components such as lenses and mirrors in the beam path of the light or also by local refractive index fluctuations of the medium through which the light beam passes, for example caused by atmospheric turbulence. The wavefronts measured or reconstructed by the wavefront sensors are used either to characterize the respective optical components through which the light passes, such as lenses, mirrors or the medium through which the light passes, or to subsequently compensate for deviations with the aid of a suitable corrector. Depending on the application in question, different properties such as high measuring accuracy, measuring speed or wavelength dependence of the wavefront sensor are important.

Accordingly, there are a variety of different measuring methods and wavefront sensors. Important representatives of this are the Shack-Hartmann sensor, as presented in the article “History in principles of Shack-Hartmann wavefront sensing” by B. C. Platt and R. Shack 2001 in the J. Refract. Surg. 17, p-573-7, the curvature sensor as presented by F. Rodier in the article “Curvature sensing and compensation: a new concept in adaptive optics” 1988 in Appl. Opt. 27, 1223, the pyramid sensor, which was presented in 1996 by R. Ragazzoni in the article “Pupil plane wavefront sensing with an oscillating prism” in J. Mod. Opt. 43 as well as interferometric measurement methods such as the Lateral Shearing Interferometer, as is known from the 1964 paper “The Use of a Single Plane Parallel Plate as a Lateral Shearing Interferometer with a Visible Gas Laser Source” by M. V. R. K. Murty in Appl. Opt. 3. Both the Shack-Hartmann sensor and the lateral shearing interferometer do not directly measure a wavefront, i.e., an optical path length difference, but a local inclination of the wavefront, a slope of the wavefront or wavefront slope for short. The wavefront can then be reconstructed from these gradient measurements.

G. Futterer, in their article “Wave front sensing for metrology by using optical filter” 2019 in the Proceedings of SPIE, presents a method in which a single transmission measurement is carried out and a measured intensity value on a sensor is converted into angles of incidence and thus into wavefront slopes with the aid of a calibration that relates the transmission to angles. The resolution of the calibration is increased by proposing several comparison measurements for the calibration under different angles of incidence of the light.

Accordingly, the problem is to overcome the disadvantages of the known methods and devices for determining a wavefront slope and to realize an improved determination of wavefront slopes.

This object is achieved by the subject matter of the independent claims. Advantageous embodiments may be found in the dependent claims, the description and the figures.

One aspect relates to a method for determining a wavefront slope of a light in at least one spatial direction, preferably two spatial directions. Preferably, the light is a laser light. Part of the method is a first irradiation of a transmission filter unit with a light with a first angle, a first angle of incidence, between the light and a main transmission direction of the transmission filter unit for the light of the first irradiation. The main transmission direction is the direction in which light passing through the transmission filter unit or a transmission filter element of the transmission filter unit, in this case preferably laser light, has the maximum intensity, i.e., the direction in which the light must be incident in order to minimize reflection and/or absorption by the transmission filter unit or the transmission filter element. The main transmission direction can therefore correspond to a local and/or global maximum of an associated transmission function. Accordingly, a first measurement of a first intensity I1 of the light transmitted through the transmission filter unit is carried out by a measuring unit. Also part of the method is a second irradiation of the transmission filter unit with the light, i.e., light from the same source, with a second angle between the light and the main transmission direction of the transmission filter unit for the light of the second irradiation. The irradiation therefore takes place at the respective different angles of incidence. Accordingly, a second measurement of a second intensity I2 of the light transmitted through the transmission filter unit at the second angle is also carried out by the measuring unit. As explained further below, the light for the first/second irradiation or measurement can be divided into corresponding partial lights which, apart from a property such as an intensity and/or a polarization, have the same or equivalent remaining properties and are therefore considered to be the same light in the context of the present disclosure.

The two angles between respective light and respective main transmission direction lie in a common measuring plane and have substantially the same angular value but different signs. The substantially equal angular values are the same or equal except for a predetermined deviation, which can be, for example, at most 45°, at most 30°, at most 15°, at most 10° or at most 5°. In the following explanations, the term “equal angular values” is used for the sake of more compact notation, wherein this is understood to mean “substantially equal angular values” unless otherwise stated. With the angles selected in this way, it is advantageously achieved that the two lights fall on the transmission filter unit at respective angles of incidence, which correspond to differently inclined edges, namely one rising and one falling edge, of the associated transmission function. One of the two angles between light and main transmission direction is therefore assigned to a rising edge of a transmission filter function assigned to the transmission filter unit and the other of the two angles between light and main transmission direction is assigned to a falling edge. The transmission filter function can therefore be described as an angle-dependent transmission filter function or angle-dependent transmission function. As a result, a certain change in the wavefront slope in the different lights results in different intensity changes and can therefore be quantified via the spatial contrast as described below.

Also part of the method is a calculation of a spatial contrast K from a difference of first intensity I1 and second intensity I2 and preferably also a sum of first intensity I1 and second intensity I2. A local wavefront slope S is determined from the calculated spatial contrast K and a specified calibration factor c of the transmission filter unit determined in a calibration procedure. The calibration factor can be specified as a simple scalar, but alternatively or additionally also in the form of a table, look-up-table, which provides the local wavefront slope for the respective contrasts and/or angles of incidence.

The local wavefront slope can, for example, be determined with spatial resolution, wherein the wavefront of the light can then be reconstructed from the known local wavefront slope(s) S using appropriate reconstruction algorithms for zonal and/or modal reconstruction. Numerous reconstruction algorithms of this type have already been developed for use with the established Shack-Hartmann sensor and can also be used in the approach described here.

This has the advantage that the angle-dependent transmission of an optical filter, the transmission filter unit, is used to convert the gradient of the wavefront into local intensity differences, specifically on the basis of a difference measurement, so that the method described is independent of local changes in irradiance over time. This is a decisive advantage, especially when used in adaptive optics systems for the measurement and correction of wavefront disturbances due to atmospheric turbulence. In addition, the difference measurement allows the respective angle of incidence of the light on the transmission filter unit to be adapted to a respective transmission function of the corresponding transmission filter element of the transmission filter unit, so that the relationship between transmission and angle of incidence is linear or quasi-linear, and as a result a simple number as a calibration factor c already enables a very high accuracy in determining the wavefront slope. As a consequence, the calibration required for the process is also simplified.

Overall, the described method for determining the wavefront slope overcomes significant disadvantages of the previously known approaches and enables more accurate, faster and more flexible measurements in a number of fields of application. The measurements of the wavefronts can be used here for the real-time measurement and correction of wavefront deformations caused by atmospheric turbulence as part of adaptive optics, as well as for the examination and quality control of optical components, for the measurement and correction of imaging errors in microscopy, for the measurement of imaging errors of the human eye in ophthalmology, and for the characterization of the optical properties of a laser beam in laser technology. In addition, the method described can also be used to achieve extremely accurate angle measurement and to measure surface structures or shapes over a large area with great precision.

In principle, a transmission filter unit with at least one transmission filter element and a measuring unit with at least one measuring or detector element are used. To measure the local wavefront slope, two measurements can be carried out for each spatial direction, x-direction and y-direction. In the method, four measurements are required for the complete measurement of a two-dimensional wavefront. For these different measurements, the transmission filter unit used or the transmission filter element used must have different angles to the optical axis of the laser beam. Accordingly, the measurements can be carried out simultaneously, as described below, if the laser beam is divided into four partial beams. In this case, it may make sense to use a separate transmission filter element and measuring or detector element for each measurement and therefore each partial beam. However, it is also possible to carry out the measurements one after the other and to rotate the transmission filter unit or a single transmission filter element involved accordingly between the measurements or to change the direction of the laser beam, as explained below.

In an advantageous embodiment, a single involved transmission filter element of the transmission filter unit is irradiated correspondingly during the first irradiation and the second irradiation. The first irradiation and the first measurement take place before the second irradiation and the second measurement, wherein the only transmission filter element of the transmission filter unit involved is tilted between the first irradiation and the first measurement and the second irradiation and the second measurement by a difference angle of the two angles about a tilting axis perpendicular to the measuring plane. The tilting axis therefore runs in such a way that at some point during the tilting process the beam path of the light coincides with the main transmission direction. Moving the light or the beam path of the light has the same effect and can be regarded as a tilting of the transmission filter element in a moving reference system of the light. This has the advantage that a smaller device with fewer components can be used.

In an advantageous embodiment, it is provided that the local wavefront slope is determined in at least one spatial direction perpendicular to the direction of propagation of the light, preferably in two (preferably orthogonal) spatial directions. A first and a second measurement are carried out for each spatial direction, wherein the spatial direction assigned to the first and second measurement lies in the measuring plane. This allows the two-dimensional local wavefront gradient to be determined.

In a further advantageous embodiment, a beam splitter unit is provided for splitting an original light, preferably an original laser light, into the light of the first irradiation and the light of the second irradiation. Since the light of the first irradiation and the light of the second irradiation have the same source, their respective properties correspond, thus they are the same light in the context of this disclosure, although the lights may differ in a property such as intensity and/or polarization. During the first irradiation, a first transmission filter element of the transmission filter unit is then irradiated and, during the second irradiation, a second transmission filter element of the transmission filter unit, which is different from the first transmission filter element, is irradiated. The two transmission filter elements are preferably functionally identical and each have the main transmission direction relevant for the first or second angle between the light and the transmission filter unit. However, the two transmission filter elements can also be embodied as a component unit, i.e., as one and the same transmission filter element, wherein the two lights are then directed onto and through the transmission filter elements from different directions and thus different angles of incidence. This is ideal for differently polarized lights as first and second light, for example. This has the advantage that the speed of the process is increased and, for example, the wavefront slope can be performed at twice the speed of the serial process from above. The number of moving parts is also reduced, which in turn reduces wear and increases accuracy.

It is particularly advantageous here to divide the original light into four lights, so that, analogously to the division into two lights with the measurement of the wavefront in one spatial direction, this can also be done for the second spatial direction in order to reconstruct a two-dimensional wavefront. Analogously to the first and second irradiation and measurement, a further first irradiation and measurement and also a further second irradiation and measurement are then carried out accordingly. This is also explained in more detail below.

In a further advantageous embodiment it is provided that the intensities are measured and the spatial contrast is calculated pixel by pixel for each of a large number of pixels. The pixels are preferably arranged two-dimensionally on a surface. Accordingly, the measuring unit is then a pixel-based measuring unit, for example with a charge-coupled device measuring or detector element (CCD detector element). This has the advantage that the resolution of the wavefront slope measurement scales with the resolution of the pixel-based measuring unit, as each measured value corresponds to the averaged wavefront slope over the corresponding pixel. This means that almost any scalability can be achieved by selecting the measuring unit and its spatial resolution.

In a further advantageous embodiment, it is provided that the angular value of the two angles corresponds to the absolute value of the angle of the largest edge steepness of a transmission function of the transmission filter unit or of the respective transmission filter element or elements relative to the associated main transmission direction, in particular is the value. In general, the angular value can also be selected as a function of the edge steepness of the transmission function in such a way that a measurement range, determined by the edge steepness, of the measurement of the measuring unit is adapted to a measurement range specified by a user. For example, the measurement range can thus also be dynamically adapted or tracked during the measurement, i.e., in real time, by readjusting or adapting the angular values. If the angular value of the two angles corresponds to the absolute value of the angle of the largest edge steepness, the relationship between local contrast and local wavefront slope S is particularly close to a linear relationship and the dynamics of the measurement are particularly pronounced, which brings with it the advantages described.

In a further advantageous embodiment, it is provided that the transmission filter unit contains at least one Fabry-Perot etalon as a respective transmission filter element with secondary main transmission directions, wherein the secondary main transmission directions correspond to the secondary transmission maxima. By selecting and setting the angular value of the first and second angle as a function of respective edge steepnesses of the transmission function of the Fabry-Perot etalon in the region of the secondary main transmission directions in such a way that a measurement range of the measurement determined by the edge steepness is adapted to a measurement range specified by a user. The angular value can therefore be selected and set as a user input via a corresponding input unit depending on the measurement range specified by the user. In particular, the selection and adjustment can also be automated or semi-automated. This means that the dynamics of the method can be adapted to the real requirements, even while the wavefront slope is being determined.

In a further advantageous embodiment, it is provided that the spatial contrast K is given as proportional to (I1−I2)/(I1+I2), preferably equal to (I1−I2)/(I1+I2). This ensures that the spatial contrast is independent of the absolute value of the intensity of the light, so that local intensity fluctuations do not influence the measured value, wherein properties of the measuring unit used, such as an associated dynamic range or sensor noise, can of course still play a role here. In particular, the local wavefront slope S is given as proportional to c*K, preferably as S=+/−c*K, i.e., a linear relationship between local wavefront slope S and spatial contrast K is assumed. This simplifies the process considerably, especially the calibration required to determine the slope of the linear sensor response, c, and has proven to be excellent in real-life testing.

A further aspect relates to a sensor device for determining a wavefront slope, having a beam splitter unit which is configured to split a light, in particular a laser light, for which the wavefront slope is to be determined, into at least a first light and at least a second light, having a first transmission filter element of a transmission filter unit which, in a beam path of the first light with a main transmission direction of the first transmission filter element, is arranged tilted by a first angle relative to the beam path of the first light, downstream of the beam splitter unit, a first measuring element of a measuring unit which is arranged in the beam path of the first light downstream of the beam splitter unit and is configured to measure a first intensity I1 of the first light transmitted through the first transmission filter element, having a second transmission filter element of the transmission filter unit which, in a beam path of the second light with a main transmission direction of the second transmission filter element, is arranged tilted by a second angle relative to the beam path of the second light, downstream of the beam splitter unit, and having a second measuring element of the measuring unit, which is arranged in the beam path of the second light downstream of the beam splitter unit and is configured to measure a second intensity I2 of the second light transmitted through the second transmission filter element. The transmission filter elements are preferably functionally identical. The two angles between the respective lights and main transmission directions lie in a common measuring plane and have substantially the same angular value, but different signs based on the assigned main transmission direction. The sensor device furthermore comprises a computing unit which is configured to calculate a spatial contrast K from a difference between the first intensity I1 and the second intensity I2 and preferably also to calculate a sum of first intensity I1 and second intensity I2 and to determine a local wavefront slope S from the calculated spatial contrast K and a predetermined calibration factor c of the transmission filter unit.

Advantages and advantageous embodiments of the sensor device correspond to advantages and advantageous embodiments of the described method, and vice versa.

The transmission filter unit can comprise one or more Fabry-Perot etalons and/or one or more interference filters as respective transmission filter elements.

A further aspect relates to a device for measuring atmospheric turbulence, with a sensor device according to one of the embodiments described, wherein additionally the beam splitter unit is configured to split the light into two first lights, namely the first light as first x-light, and an additional first light as first y-light, and into two second lights, the second light as second x-light, and an additional second light as second y-light. In addition to first and second transmission filter elements, which can then be referred to as first x-transmission filter element and second x-transmission filter element, an additional first transmission filter element, a first y-transmission filter element, is then, in a beam path of the first y-light with a main transmission direction of the first y-transmission filter element, also arranged tilted relative to the beam path of the first y-light by an additional first angle, a first y-angle, downstream of the beam splitter unit. Accordingly, in addition to the first measuring element, which can now be referred to as the first x measuring element, and the second measuring element, which can accordingly be referred to as the second x measuring element, an additional first measuring element, a first y-measuring element, is arranged in the beam path of the first y light downstream of the beam splitter unit and is configured to measure an additional first intensity, a first y intensity I1-y of the first y light transmitted through the first y transmission filter element.

The device also has an additional second transmission filter element, a second y-transmission filter element, which, in a beam path of the second y-light with a main transmission direction of the second y-transmission filter element, is arranged tilted relative to the beam path of the second y-light by an additional second angle, a second y-angle, downstream of the beam splitter unit. An additional second measuring element, a second y-measuring element, is also arranged in the beam path of the second y-light downstream of the beam splitter unit and is configured to measure an additional second intensity, a second y-intensity I2-y of the second y-light transmitted through the second y-transmission filter element. The additional y-transmission filter elements are preferably functionally identical to each other and/or to the x-transmission filter elements.

The two y-angles between the respective y-lights and main transmission directions lie in a common measuring plane, a y-measuring plane, and have substantially the same angular value but different signs. The y-measuring plane is oriented transversely, in particular perpendicularly, to the measuring plane of the angles between the respective x-lights and main transmission directions of the assigned transmission filter elements, of the x-measuring plane.

In addition to the spatial contrast K (or K-x) from the intensities I1 and I2 (or I1-x and I2-x) measured with the x-measuring elements, the computing unit is accordingly configured to calculate an additional spatial contrast K-y from a difference of first y-intensity I1-y and second y-intensity I2-y and preferably also a sum of first y-intensity I1-y and second y-intensity I1-y and to determine an additional local wavefront slope S-y from the calculated additional contrast K-y and a predetermined calibration factor cy, which may be, but does not have to be, identical to the calibration factor c, which can also referred to as the calibration factor cx, of the transmission filter unit, and to calculate a two-dimensional local wavefront slope S or S-xy from the local wavefront slope S as the wavefront slope S-x in the direction of the x-measuring plane and the additional wavefront slope S-y in the y-measuring plane. Preferably, the computing unit is also configured to reconstruct a two-dimensional wavefront of the light from the determined two-dimensional local wavefront slope S using a reconstruction algorithm for zonal and/or modal reconstruction. The described advantages and advantageous embodiments of the sensor device apply analogously.

The features and combinations of features mentioned above in the description, also in the introductory part, as well as the features and combinations of features mentioned below in the description of the figures and/or shown alone in the figures may be used not only in the combination indicated in each case, but also in other combinations, without departing from the scope of the invention. Thus, embodiments which are not explicitly shown and explained in the figures, but which emerge from the explained embodiments and may be produced by separate combinations of features, are also to be regarded as comprised and disclosed by the invention. Embodiments and combinations of features which thus do not have all the features of an originally formulated independent claim are also to be regarded as disclosed. Furthermore, embodiments and combinations of features are to be regarded as disclosed, in particular by the embodiments set out above, which go beyond or deviate from the combinations of features set out in the references of the claims.

The subject matter according to the invention will be explained in greater detail on the basis of the following figures and schematic drawings, without wishing to limit these to the specific embodiments shown here.

The figures show:

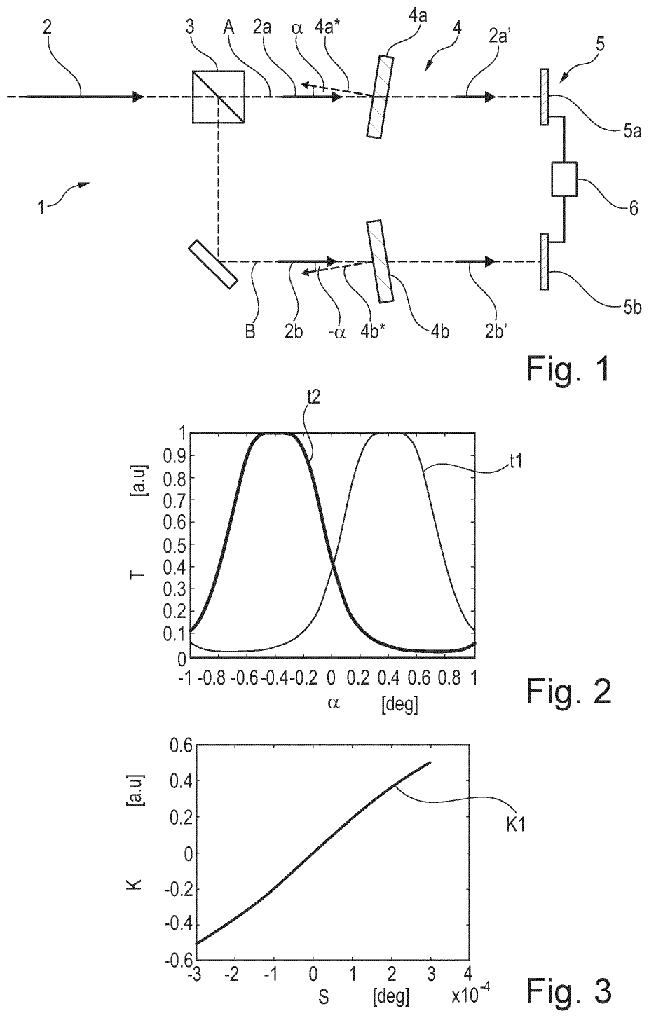

FIG. 1 a schematic view of an exemplary sensor device for determining a wavefront slope;

FIG. 2 exemplary transmission functions of two transmission filter elements of a transmission filter unit;

FIG. 3 an exemplary calibration function for a transmission filter unit; and

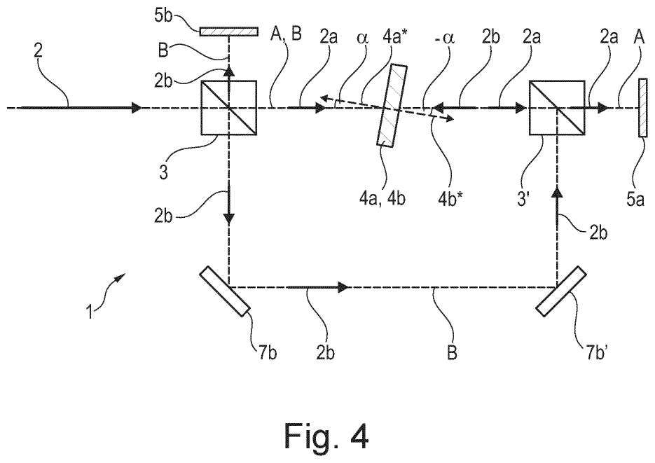

FIG. 4 a schematic view of a further exemplary sensor device for determining a wavefront slope.

In the different figures, like or functionally like elements are provided with like reference signs.

FIG. 1 shows an exemplary embodiment of a sensor device 1 for determining a wavefront slope of a light 2. The sensor device 1 has a beam splitter unit 3, which is configured to split the light 2 into at least a first light 2a and at least a second light 2b. The sensor device 1 has a transmission filter unit 4 with a first transmission filter element 4a and a second transmission filter element 4b. These transmission filter elements 4a, 4b are arranged in beam paths A, B of the respective associated first light 2a or second light 2b. Relative to the beam path A of the first light 2a, the first transmission filter element 4a is arranged with an associated main transmission direction 4a* tilted relative to the beam path A by a first angle α. The second transmission filter element 4b is arranged accordingly in the beam path B of the second light 2b, more specifically with its main transmission direction 4b* tilted by a second angle −α relative to the beam path B. A measuring plane in which both angles α, −α and the main transmission directions 4a*, 4b* lie coincides with the drawing plane in the present case

The sensor device 1 also has a measuring unit 5 with a first measuring element 5a and a second measuring element 5b. The first measuring element is arranged in the beam path A of the first light downstream of the beam splitter unit 3 and downstream of the transmission filter element 4a and is configured to measure a first intensity I1 of the first light 2a′ transmitted through the first transmission filter element 4a. The second measuring element 5b, which is arranged in the beam path B of the second light 2b downstream of the beam splitter unit 3 and is configured to measure a second intensity I2 of the second light 2b′ transmitted through the second transmission filter element 4b. The two transmission filter elements are functionally identical and can, for example, be of the same design.

The two angles α, −α between the respective lights 2a, 2b and main transmission directions 4a*, 4b* lie in the common measuring plane and have the same angular value but different signs, which is expressed in their names. A computing unit 6 is coupled to the measuring elements 5a, 5b and is configured to calculate a spatial contrast K from a difference between the first intensity I1 and the second intensity I2 and a sum of the two intensities I1, I2 and also to determine a local wavefront slope S from the calculated spatial contrast K and a predetermined calibration factor of the transmission filter unit 4.

According to the exemplary sensor device 1 shown, the measuring principle for the wavefront slope S in one spatial direction is now presented. The determination of a two-dimensional wavefront slope S-xy results analogously from the combination of the determination for one spatial direction.

The transmission T (FIG. 2) of the filter elements 4a, 4b depends on the angle of incidence α, −α of the laser beam 2a, 2b. Suitable filter types are, for example, but not necessarily Fabry-Perot etalons and/or interference filters. If, for example, a transmission function of a transmission filter element 4a, 4b is given by a Gaussian function with the (main) maximum at perpendicular incidence, i.e., an angle of incidence of α=0, the transmission decreases accordingly for light beams 2a, 2b that impinge on the transmission filter element 4a, 4b at a smaller or larger angle. If a deformed wavefront now impinges on the transmission filter elements 4a, 4b, the transmission is at a maximum in the region of the wavefront with a gradient of 0, and, the greater the gradient, the less light is transmitted at these points.

This information could already be used to determine the local gradient S. However, it is not possible to distinguish whether the angle of incidence is positive or negative, as the symmetrical transmission curve t1, t2 (FIG. 2) of the filter element 4a, 4b and the transmission maximum at 0° both result in the same transmission T and therefore the same measured intensity. In addition, the relationship between transmission T and wavefront slope S is not linear, but corresponds to the transmission function t1, t2. However, a decisive problem for many applications is the dependence of the transmitted intensity values on the spatial intensity distribution of the laser beam. If this is not constant over time and varies quickly, the problem cannot be solved by additional calibration steps.

If the direction of propagation of the laser beam is not perpendicular to the filter element 4a, 4b, for example because the filter element 4a, 4b has been rotated on the optical axis, i.e., the beam path A, B, the smallest wavefront slope of 0° is no longer transmitted at maximum, but that which corresponds to the negative of the (rotation) angle α, −α of the transmission filter element 4a, 4b. The operating point on the transmission curve t1, t2 of the filter element 4a, 4b is thus shifted in the stated example of the Gaussian curve to the rising and falling edge, depending on the direction of rotation. By rotating the transmission filter element 4a, 4b, a unique transmission value T and thus a unique measured intensity I can be assigned to each wavefront slope S in the measuring range and a distinction can be made between positive and negative angles. This is also explained again below in conjunction with FIG. 3.

The exemplary wavefront sensor shown in FIG. 1 as a sensor device 1 for determining the wavefront slope utilizes this effect. The light 1 is first divided into two partial lights 2a, 2b, and both partial lights 2a, 2b are each guided onto a transmission filter element 4a, 4b. The two lights 2a, 2b do not strike the transmission filter elements 4a, 4b perpendicularly, but at just opposite angles α, −α. Thus, in the example of a transmission function as a Gaussian curve with a maximum at 0°, the measurement range for the first light 2a is on the rising edge of the transmission curve t1 and the measurement range for the second light 2b is on the falling edge of the transmission curve t2. With a symmetrical transmission curve, the transmission value T should be identical for wavefront regions without a slope, i.e., an angle of incidence of 0°, but no longer maximum due to the rotations different from 0°. Negative angles lead to a lower transmission T for the first light 2a, but to an increased transmission T for the second light 2b. The opposite is true for positive incident angles, which lead to a higher transmission T for the first light 2a, 2a′, but to a lower transmission T for the second light 2b, 2b′. The two corresponding transmission curves t1, t2 of the two transmission filter elements 4a, 4b tilted by α=0.4° and −α=−0.4° respectively in this example are shown in FIG. 2.

FIG. 2 accordingly shows the exemplary transmission curve t1 of the first transmission filter element 4a and the exemplary transmission curve t2 of the second transmission filter element 4b with the respective transmission T over the angle of incidence α, here for the exemplary tilt of +0.4° for the first transmission filter element 4a and −0.4° for the second transmission filter element 4b. After transmission, the two lights 2a1, 2b′ are detected by the two measuring elements 5a, 5b and the respective individual intensities I1, I2 of an intensity distribution I are recorded. The evaluation, i.e., the generation of the sensor or measurement response, consists of a very simple calculation step, as the spatial contrast K between the two detector images as a sensor measurement value has an almost linear relationship with the local gradient of the wavefront S, which is shown as an example in FIG. 3. Accordingly, the spatial contrast can be calculated pixel by pixel for the case of pixel CCD measuring elements 5a, 5b, for example, by dividing the difference between the respective intensity measurements I1, I2 of the first and second measuring elements 5a, 5b by their sum. Division by the total local intensity, the sum of the two intensity measurements at the location, means that the sensor measured value is independent of the absolute intensity of light 2. Local intensity fluctuations therefore do not influence the measured value.

FIG. 3 shows an example of such a local contrast K as a function of the local wavefront slope S, and thus the angle of incidence, as curve K1. Due to the almost linear relationship between local contrast K and local wavefront slope S, it is sufficient to know the slope c of this relationship in order to determine the wavefront slope from the sensor measurement. The sensor slope c can be determined as a simple scalar in a calibration process. This means that the local angles of incidence and thus the local slopes S of the wavefront are known, so that the reconstruction algorithms known from other methods can be used to calculate the wavefront from the wavefront slopes.

FIG. 4 shows a further exemplary embodiment of a sensor device 1 for determining a wavefront slope of a light 2. In contrast to the embodiment of FIG. 1, the beam splitter unit 3 is configured to split the light 2 into the at least one first light 2a and the at least one second light 2b according to a polarization, for example into the first light 2a as p-polarized light and the second light as s-polarized light. As described for FIG. 1, the first light 2a passes through the first transmission filter element 4a downstream of the beam splitter unit 3 at the angle α and then, after passing through a further beam splitter element 3′ for splitting light according to its polarization, impinges on the measuring element 5a.

In the example shown, the second light 2b is directed via respective deflection elements 7b, 7b′ and the further beam splitter element 3′ onto the first transmission filter element 4a, which in the present case also serves as the second transmission filter element 4b, since the second light 2b is guided on the beam path A of the first light 2a in the opposite direction at the angle-a through the transmission filter element 4b. After passing through the transmission filter element 4b, the second light 2b is directed to the measuring element 5b, in this case by the beam splitter unit 3.

1-14. (canceled)

15. A method for determining a wavefront slope, comprising a
(a1) first irradiation of a transmission filter unit with a light, with a first angle between the light and a main transmission direction of the transmission filter unit for the light;
(a2) first measurement of a first intensity of the light transmitted through the transmission filter unit;
(b1) second irradiation of the transmission filter unit with the light, with a second angle between the light and the main transmission direction of the transmission filter unit for the light;
(b2) second measurement of a second intensity of the light transmitted through the transmission filter unit;
wherein one of the two angles between the light and the main transmission direction is assigned to a rising edge of a transmission filter function assigned to the transmission filter unit and the other of the two angles between the light and the main transmission direction is assigned to a falling edge of the transmission filter function assigned to the transmission filter unit; and by a
(c) calculation of a spatial contrast from a difference between the first intensity I1 and the second intensity I2; and
(d) determination of a local wavefront slope from the calculated spatial contrast and a calibration factor of the transmission filter unit determined in a calibration procedure.

16. The method according to claim 15, wherein the two angles between the light and main transmission direction lie in a common measuring plane and have substantially the same angular value but different signs.

17. The method according to claim 16, wherein the spatial contrast K is calculated from the difference between the first intensity I1 and the second intensity I2 and a sum of the first intensity I1 and the second intensity I2.

18. The method according to claim 16, wherein reconstruction of the wavefront of the light is carried out from the determined local wavefront slope by utilizing a reconstruction algorithm for zonal and/or modal reconstruction.

19. The method according to claim 16, wherein
a single transmission filter element of the transmission filter unit is irradiated during the first irradiation and the second irradiation; wherein
the first irradiation and first measurement take place at a time before the second irradiation and second measurement and the single transmission filter element of the transmission filter unit is tilted by a difference angle of the two angles between the first irradiation and first measurement and the second irradiation and second measurement.

20. The method according to claim 16, wherein the local wavefront slope is determined in at least one spatial direction, and a first and a second measurement are carried out for each spatial direction, wherein the spatial direction assigned to the respective first and second measurement lies in the measuring plane.

21. The method according to claim 16, wherein splitting an original light into the light of the first irradiation and the light of the second irradiation so that a first transmission filter element of the transmission filter unit is irradiated during the first irradiation and a second transmission filter element of the transmission filter unit, which differs from the first transmission filter element, is irradiated during the second irradiation, wherein the two transmission filter elements are functionally identical and each have the main transmission direction relevant for the first or second angle between the light and the transmission filter unit.

22. The method according to claim 15, wherein the intensities are measured and the spatial contrast is calculated pixel by pixel for a large number of pixels.

23. The method according to claim 16, wherein the angular value of the two angles corresponds to the absolute value of the angle of the greatest edge steepness of a transmission function of the transmission filter unit relative to the main transmission direction.

24. The method according to claim 16, wherein:
the transmission filter unit contains at least one Fabry-Perot etalon as transmission filter element with secondary main transmission directions; and by a
selection and setting of the angular value of the first and second angle as a function of respective edge slopes of a transmission function of the Fabry-Perot etalon in the region of the secondary main transmission directions in such a way that a measurement range of the measurement determined by the edge slope is adapted to a measurement range specified by a user.

25. The method according to claim 15, wherein the spatial contrast is given as proportional to (I1−I2)/(I1+I2).

26. A sensor device for determining a wavefront slope, comprising
a beam splitter unit which is configured to split a light, for which the wavefront slope is to be determined, into at least a first light and at least a second light;
a first transmission filter element, which is arranged in a beam path of the first light with a main transmission direction tilted by a first angle relative to the beam path;
a first measuring element, which is arranged in the beam path of the first light downstream of the beam splitter unit and is configured to measure a first intensity I1 of the first light transmitted through the first transmission filter element;
a second transmission filter element, which is arranged in a beam path of the second light with a main transmission direction tilted by a second angle relative to the beam path;
a second measuring element, which is arranged in the beam path of the second light downstream of the beam splitter unit and is configured to measure a second intensity I2 of the second light transmitted through the second transmission filter element; wherein
the two angles between the respective lights and main transmission directions lie in a common measuring plane and have substantially the same angular value but different signs; and by a computing unit which is configured to calculate a spatial contrast from a difference between the first intensity I1 and the second intensity I2 and to determine a local wavefront slope from the calculated spatial contrast and a predetermined calibration factor c of the transmission filter unit.

27. The sensor device according to claim 26, wherein the transmission filter unit comprises one or more Fabry-Perot etalons and/or one or more interference filters as respective transmission filter elements.

28. A device for measuring a wavefront slope for a turbulent medium, comprising a sensor device according to claim 26, wherein
the beam splitter unit is configured to split the light into two first lights, the first light (2a), first x-light (2a), and an additional first light, first y-light, and into two second lights, the second light, second x-light, and an additional second light, second y-light;
an additional first transmission filter element, a first y-transmission filter element, which is arranged in a beam path of the first y-light with a main transmission direction tilted relative to the beam path by an additional first angle, a first y-angle;
an additional first measuring element, a first y-measuring element, is arranged in the beam path of the first y-light downstream of the beam splitter unit and is configured to measure an additional first intensity, a first y-intensity I1-y of the first y-light transmitted through the first y-transmission filter element;
an additional second transmission filter element, a second y-transmission filter element which is arranged in a beam path of the second y-light with a main transmission direction tilted relative to the beam path by an additional second angle, a second y-angle;
an additional second measuring element, a second y-measuring element, is arranged in the beam path of the second y-light downstream of the beam splitter unit and is configured to measure an additional second intensity, a second y-intensity I2-y of the second y-light transmitted through the second y-transmission filter element; wherein
the two y-angles between the respective y-lights and main transmission directions lie in a common measuring plane, a y-measuring plane, and have substantially the same angular value but different signs;
the y-measuring plane is orientated transversely to the measuring plane of the angles between the respective x-lights and main transmission directions of the assigned transmission filter elements of the x-measuring plane; and in that
the computing unit is configured to calculate the spatial contrast K as spatial contrast K-x from the difference of first intensity I1-x and second intensity I2-x and a sum of first intensity I1-x and second intensity I2-x, to calculate an additional spatial contrast K-y from a difference of first y-intensity I1-y and second y-intensity I2-y and also a sum of first y-intensity I1-y and second y-intensity I2-y and to determine an additional local wavefront slope S-y from the calculated additional contrast K-y and the predetermined calibration factor c of the transmission filter unit, and to calculate a two-dimensional local wavefront slope S from the local wavefront slope S as wavefront slope S-x in the direction of the x-measuring plane and the additional wavefront slope S-y in the y-measuring plane.
